(19) United States
(12) Patent Application Publication
(10) Pub. No.: US 2002/0051956 A1
(43) Pub. Date: May 2, 2002

(54) System and method for remote learning, such as for costs and benefits personnel and professionals

(76) Inventor: David J. Thomsen, Newport Beach, CA (US)

Correspondence Address: PERKINS COIE LLP, PATENT-SEA, P.O. BOX 1247, SEATTLE, WA, 98111-1247, US

(21) Appl. No.: 09/849,454

(22) Filed: May 4, 2001

Related U.S. Application Data
(60) Provisional application No. 60/203,086, filed on May 9, 2000.

(51) Int. Cl. G09B 19/00

(52) U.S. Cl. 434/219

(57) ABSTRACT

A system and method for remote learning, such as in the area of compensation and benefits for costs and benefits personnel and professionals. The method can include receiving over a computer network a user request to access a remote course, providing course material for the requested, and providing a virtual picture frame wherein the frame surrounds the course material and includes one or more links to executable applications relevant to the requested course. The method can further include receiving a user request to access through a link in the virtual picture frame an executable application, executing the application and providing a display of the content of the application.

### CROSS-REFERENCE TO RELATED APPLICATIONS

The present application claims priority to U.S. Provisional Application No. 60/203,086, filed May 9, 2000 incorporated herein in its entirety by reference.

### TECHNICAL FIELD

The following relates generally to remote learning, such as in the area of compensation and benefits.

### BACKGROUND

The Internet is increasingly being used to provide a remote learning environment in part, because it allows flexibility in learning through interactive exchanges of information. The Internet comprises a vast number of computers and computer networks interconnected through communication channels. The Internet facilitates interactive remote learning, in part, because it uses standardized techniques for exchanging information. Many standards have been established for exchanging information over the Internet, such as electronic mail, Gopher, and the World Wide Web (“WWW”). The WWW service allows a server computer system (i.e., web server or web site) to send graphical web pages of information to a remote client computer system. The remote client computer system can then display the web pages. Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends the requested web page to the client computer system. When the client computer system receives that web page, it typically displays the web page using a browser. A browser is typically a special-purpose application program for requesting and displaying web pages.

Currently, web pages are often defined using HyperText Markup Language (“HTML”). HTML provides a standard set of tags that defines how a web page is to be displayed. When a user makes a request to the browser to display a web page, the browser sends the request to the server computer system to transfer to the client computer system an HTML document that defines the web page. When the requested HTML document is received by the client computer system, the browser displays the web page as defined by the HTML document. The HTML document contains various tags that control the display of text, graphics, controls, and other features. The HTML document may contain URLs of other web pages available on that server computer system or on other server computer systems.

Traditional learning systems employing the Internet utilize small JavaScript applications that require a user to answer a question before moving to the next web page, which can be time consuming. In addition, the Java applications of the traditional learning systems produce compatibility problems with some browsers. Interactivity in learning systems via the Internet is achieved by using HTML, with small JavaScript applications. This, however, requires large programs to operate on a distant file server, making the system very expensive and slow. Accordingly, there exists a need for a system that addresses these and other problems.

### BRIEF DESCRIPTION OF THE DRAWINGS

FIG. 1 is a schematic block diagram illustrating an environment for use with an embodiment of the claimed invention.

FIG. 2 is a schematic block diagram illustrating in further detail components of the client computer shown in FIG. 1.

FIG. 3A and 3B are flow diagrams illustrating basic processes performed by the system of FIG. 1.

FIG. 4 is a data flow diagram illustrating the flow of data and steps performed under the process shown in FIG. 1.

FIG. 5 is a screen shot showing a home web page for a remote learning system, including a display description for a virtual picture frame.

FIGS. 6A-6C, together are screen shots of an alternative embodiment for displaying a home web page for a remote learning system, including a display description for a virtual picture frame.

FIG. 7 is a screen shot of a page of a course catalog.

FIGS. 8A and 8B are screen shots of a user login and enrollment web page for use by the system of FIG. 1.

FIG. 9 is a screen shot of a page of text from a remote course, such as, “Preparing to be an Expert Witness.”

FIG. 10 is a screen shot of a library of programs included in the remote learning system of FIG. 1.

FIG. 11 is a screen shot of a website homepage for an organization that provides the remote learning system of FIG. 1.

FIG. 12 is a screen shot of a program, such as the Executive Compensation Assessor, employed in the remote learning system of FIG. 1.

FIG. 13 is a screen shot of a tutorial for a program such as the Executive Compensation Assessor, employed in the remote learning system of FIG. 1.

FIG. 14 is a screen shot of a program used in a case study in the remote learning system of FIG. 1.

FIG. 15 is a screen shot of a text book chapter employed in the remote learning system of FIG. 1.

FIG. 16 is a screen shot of a web page of an organization that provides survey information.

FIG. 17 is a screen shot of a web page of an organization that provides reference information.

FIG. 18 is a screen shot a web page of an organization that provides a collection free information related to compensation and benefits.

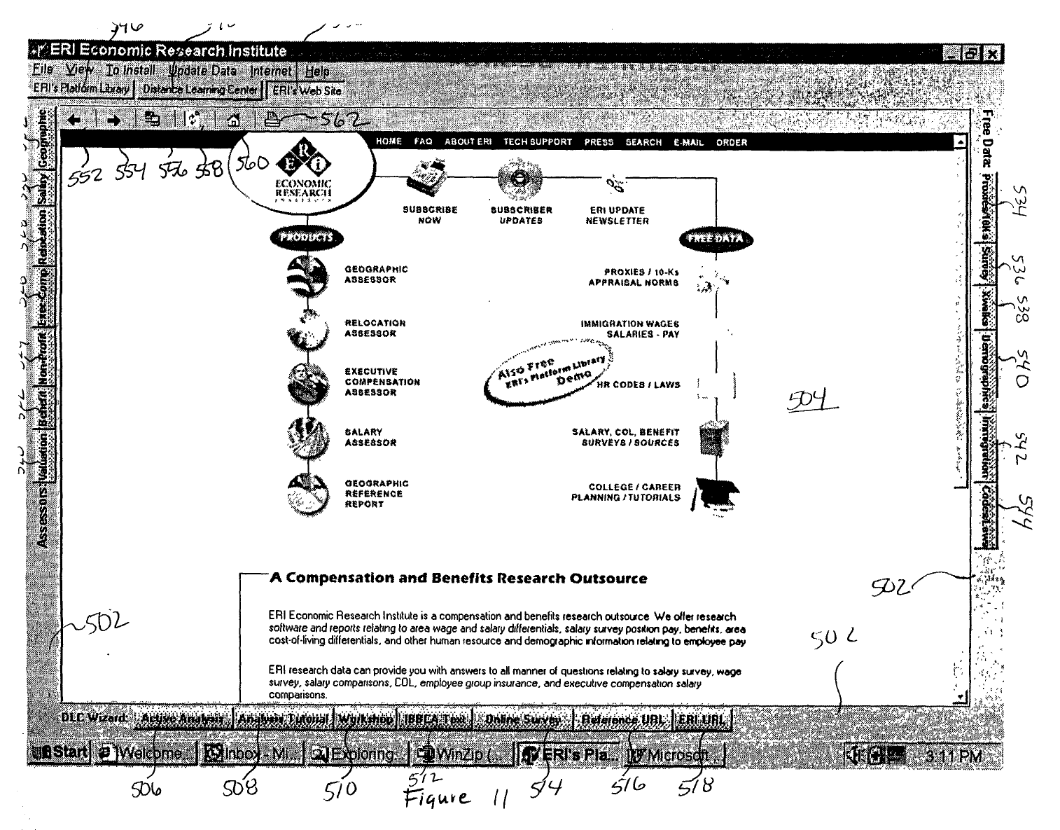

In the drawings, identical reference numbers identify identical or substantially similar elements or acts. To easily identify the discussion of any particular element or act, the most significant digit or digits in a reference number refer to the Figure number in which that element is first introduced (e.g., element 1104 is first introduced and discussed with respect to FIG. 11).

A portion of this disclosure contains material to which a claim for copyright is made. The copyright owner has no objection to the facsimile reproduction by anyone of the patent document or the patent disclosure (including Figures), as it appears in the Patent and Trademark Office patent file or records, but reserves all other copyright rights whatsoever.

### DETAILED DESCRIPTION

The following description provides specific details for a thorough understanding of, and enabling description for, embodiments of the invention. However, one skilled in the art will understand that the invention may be practiced without these details. In other instances, well-known structures and functions have not been shown or described in detail to avoid unnecessarily obscuring the description of the embodiments of the invention. In general, alternatives and alternate embodiments described in this application are substantially similar to previously described embodiments, and common elements and acts or steps are identified by the same reference numbers. Only significant differences in construction or operation are described in detail.

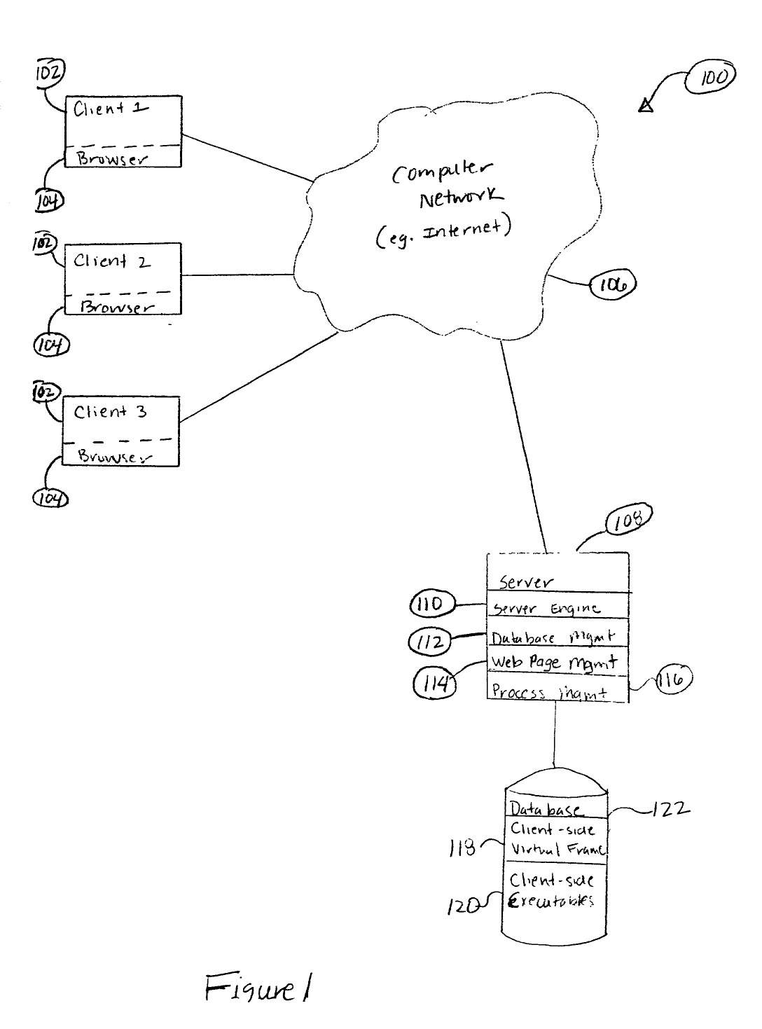

FIG. 1 and the following discussion provide a brief, general description of a suitable computing environment in which an embodiment of the invention can be implemented. Although not required, the embodiments of the invention will be described in the general context of computer-executable instructions, for example, routines executed by a general-purpose computer, such as a personal computer. Those skilled in the relevant art will appreciate that the invention can be practiced with other computer system configurations, including Internet appliances, set-top boxes, wearable computers, hand-held devices, mobile phones, multiprocessor systems, multiprocessor-based or programmable consumer electronics, network PCs, minicomputers, mainframe computers, and the like. The invention can be embodied in a specific-purpose computer or data processor that is specifically programmed, configured or constructed to perform one or more of the computer-executable instructions explained in detail below. The invention can also be practiced in distributed computing environments where tasks or modules are performed by remote processing devices, which are linked through a communications network. In a distributed computing environment, program modules or sub-routines may be located in both local and remote memory storage devices. In general, while hardware platforms, such as terminals and controllers are described herein, aspects of the invention are equally applicable to nodes on the network having corresponding resource locators to identify such nodes.

Referring to FIG. 1, a remote learning system 100, includes one or more client computers 102, each of which includes a browser program module 104 that permits the computer to access and exchange data with the Internet, including web sites within a World Wide Web (“Web”) portion 106 of the Internet. The client computers 102 may include one or more central processing units or other logic processing circuitry, memory, input devices (e.g., keyboards and pointing devices), output devices (e.g., display devices and printers), and storage devices (e.g., fixed, floppy and optical disk drives, magnetic cassettes, flash memory cards, digital video disks (DVDs), Bernoulli cartridges, RAMs, ROMs, smart cards, etc.), and other devices, all well known but not shown in FIG. 1. The client computers 102 may also include other program modules, such as an operating system, one or more application programs (e.g, word processing or spread sheet applications), and the like. Users such as compensation and benefits managers, college instructors, accountants, lawyers and insurance agents can operate the client computers 102.

A server computer 108, coupled to the Internet 106, performs some or all of the data retrieval and display processes. A database 122, coupled to the server computer 108, stores much of the data and applications exchanged between the client computers 102 and the server computer 108 as described below, including a client-side virtual picture frame application 118 and client-side executables 120. The server computer 108 includes a server engine 110, a database management component 112, a web page management component 114, a process management component 116, as well as other components not shown in FIG. 1. The server engine 110, the database management component 112, the web page management component 114, and the process management component 116 operate together to retrieve information from the database 122 and provide the information to the client computers 102. In one embodiment, the server computer 108 and the database 122 can form a single computing platform. Alternatively, the functions performed by the server computer 108 and/or the database 122 can be distributed over a plurality of platforms.

In one embodiment, the system 100 can include a first component (e.g., a first software component) installed on the client computer 102 and/or a second component (e.g., a second software component) that operates on the client computer 102, the Internet 106, and the server computer 108. In other embodiments, the system 100 can have other arrangements; for example, the two components of the system 100 can be coupled.

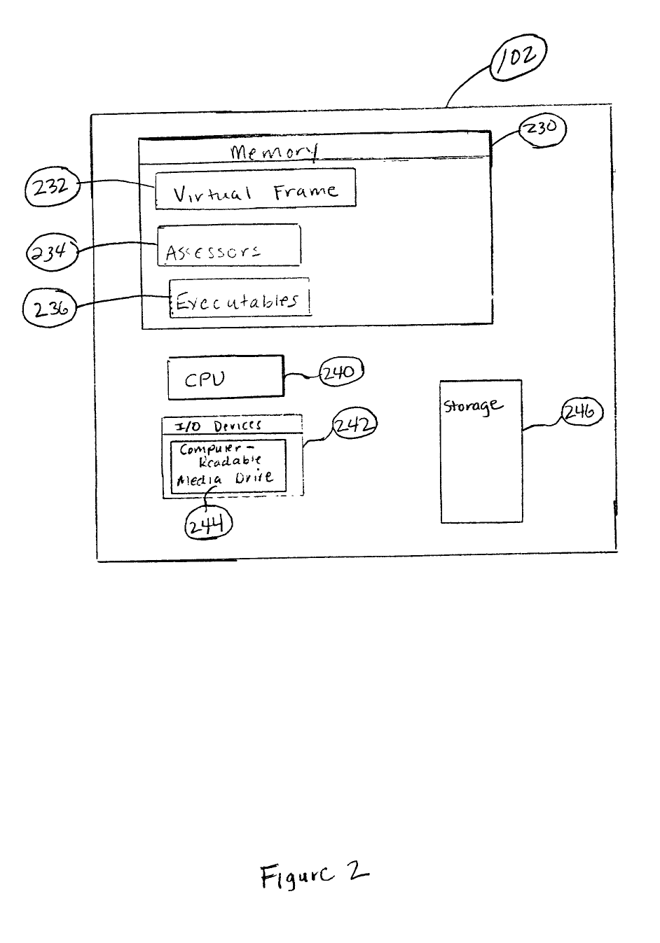

FIG. 2 is a schematic block diagram illustrating in further detail components of the client computer 102 shown in FIG. 1. In one embodiment, the computer 102 can include a memory 230, a CPU 240, input/output devices 242 and a storage device 246. The memory 230 can include software or other computer instructions for implementing a method in accordance with an embodiment of the invention, as well as an operating system, such as, Windows by Microsoft Corporation. For example, the memory 230 can store five modules, such as a Salary Assessor for providing salary data, a Relocation Assessor for providing cost of living data, a Geographic Assessor for providing salary data in one location based on a salary in another location, an Executive Compensation Assessor for providing executive compensation data, and a Benefit Assessor for providing employee benefit data. The Assessors are referred to collectively herein as “Assessors” 234, and described at www.erieri.com and are disclosed in co-pending U.S. Application No. ______ entitled “System and Method for Retrieving and Displaying Data, such as Economic Data, Relating to Salaries, Cost of Living and Employee Benefits” (attorney docket no. 33362.8001US) filed concurrently herewith, assigned to the assignee of the present application, and incorporated herein by reference. The memory 230 could also store a virtual picture frame application 232 and executables 236.

The input/output devices 242 can include devices such as a computer-readable media drive 244. Accordingly, the input/output devices 242 can read computer-readable media having the software for the Assessors 234. For example, the Assessors 234 and the virtual picture frame 232 can be contained on a CD and read by a CD drive. The software can also be accessible from the memory 230, as described above. Alternatively, the Assessors 234 and the virtual picture frame 232 can be accessed over the Web 106, and can be installed on the server computer 108 (FIG. 1). The storage device 246 can include file storage for data generated and/or accessed by the Assessors 248.

Unless described otherwise, the construction and operation of the various blocks shown in FIG. 1 and 2 are of conventional design. As a result, such blocks need not be described in further detail herein, as they will be readily understood by those skilled in the relevant art.

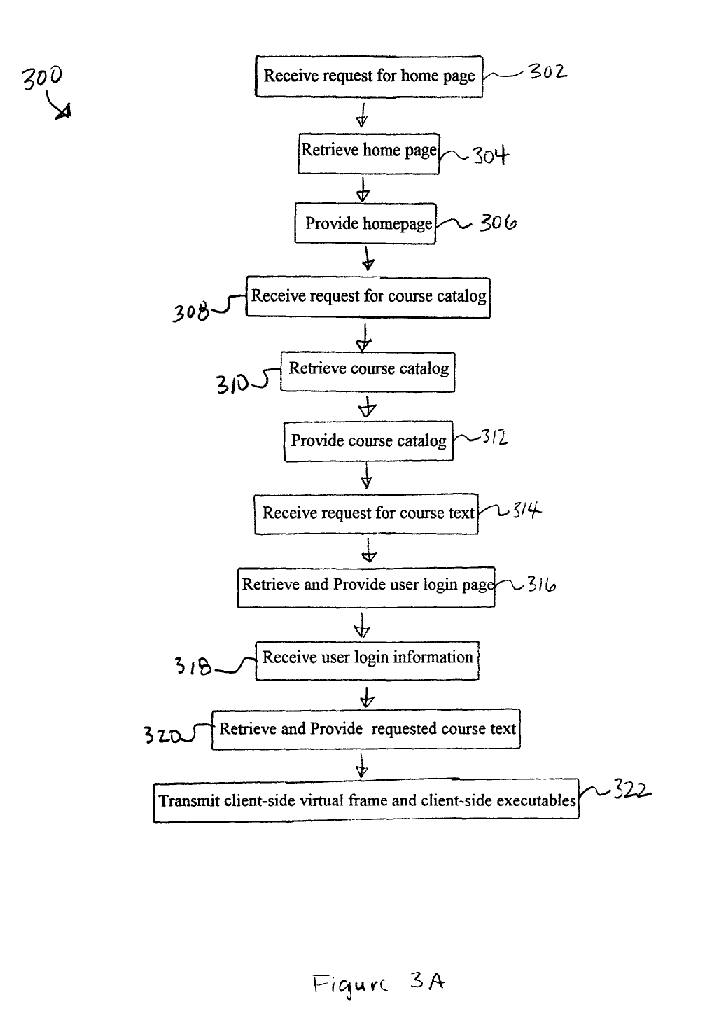

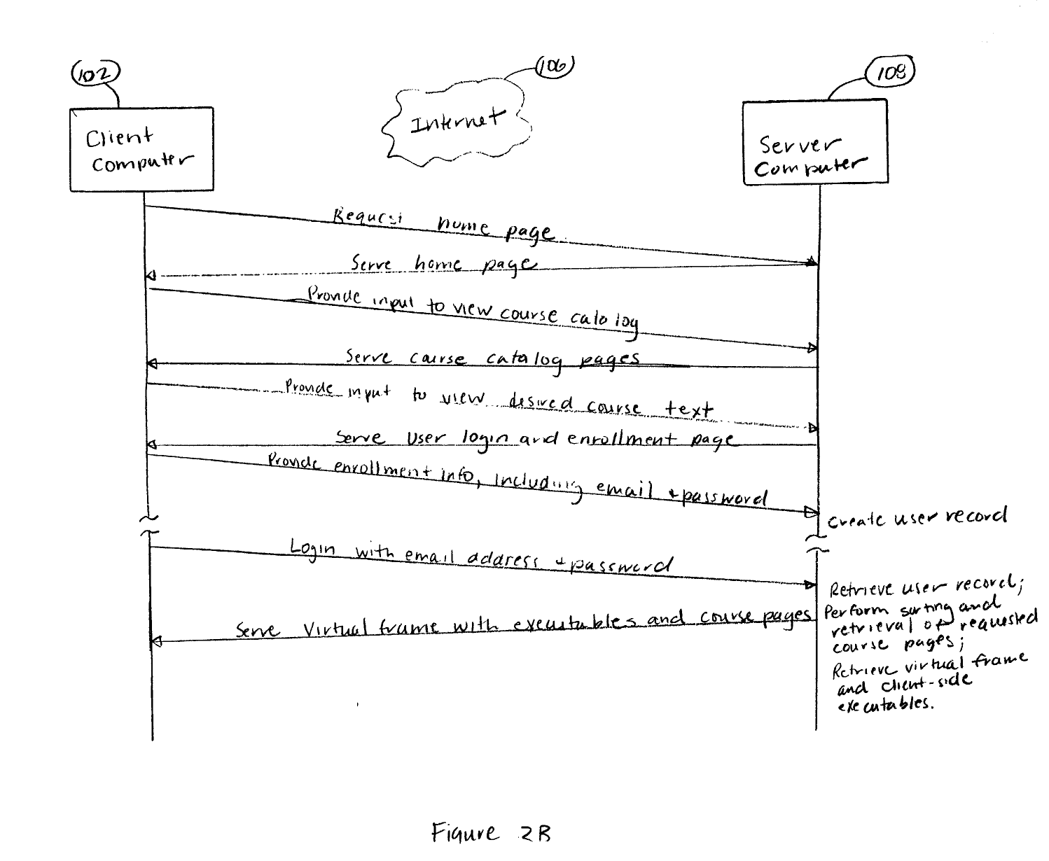

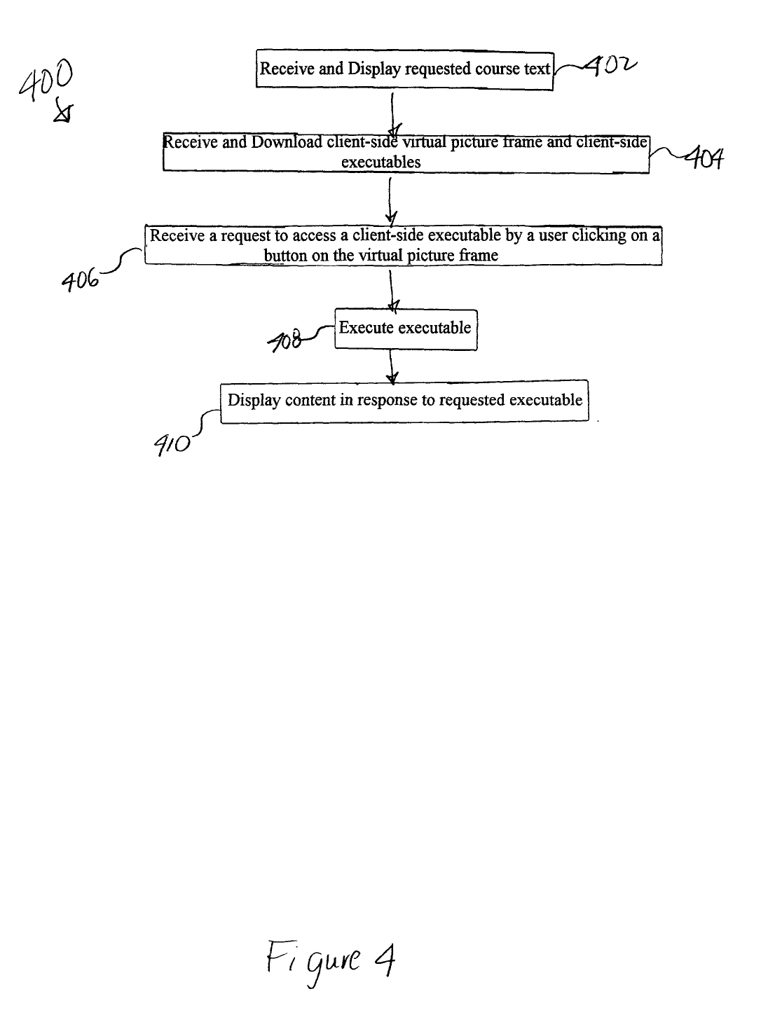

FIG. 3A is a flow diagram of a representative retrieval and display process 300 performed generally by the server 108 (FIG. 1). FIG. 3B is a data flow diagram illustrating the exchange of commands and data (through the Internet) between a client computer 102 and the server computer 108, representative of the steps involved in the process 300 (FIG. 3A) performed generally by the system 100 (FIG. 1). FIG. 4 is a flow diagram of a representative retrieval and display process 400 performed generally by the client computer 102 (FIG. 1).

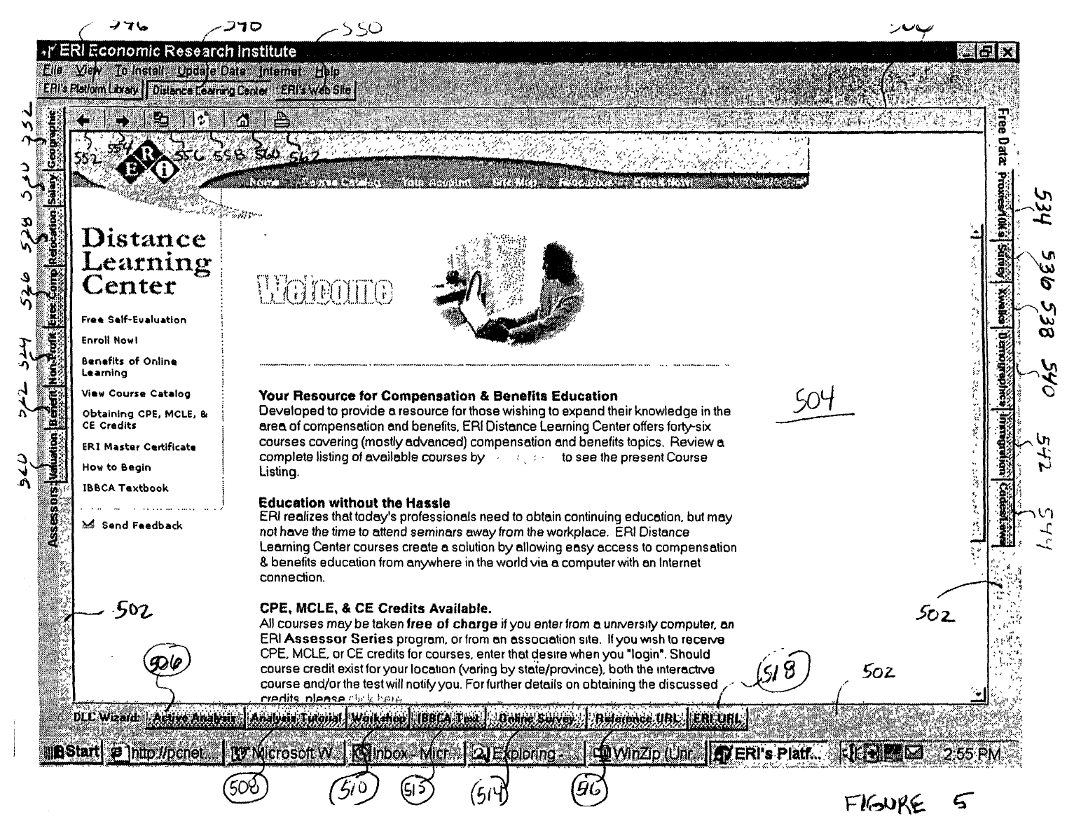

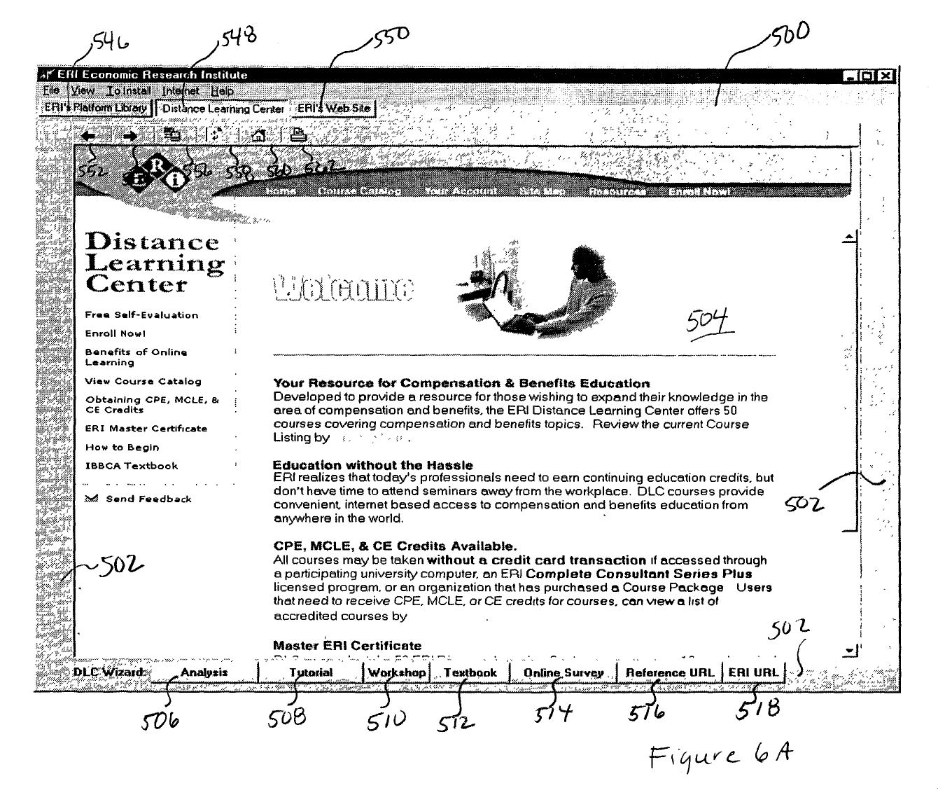

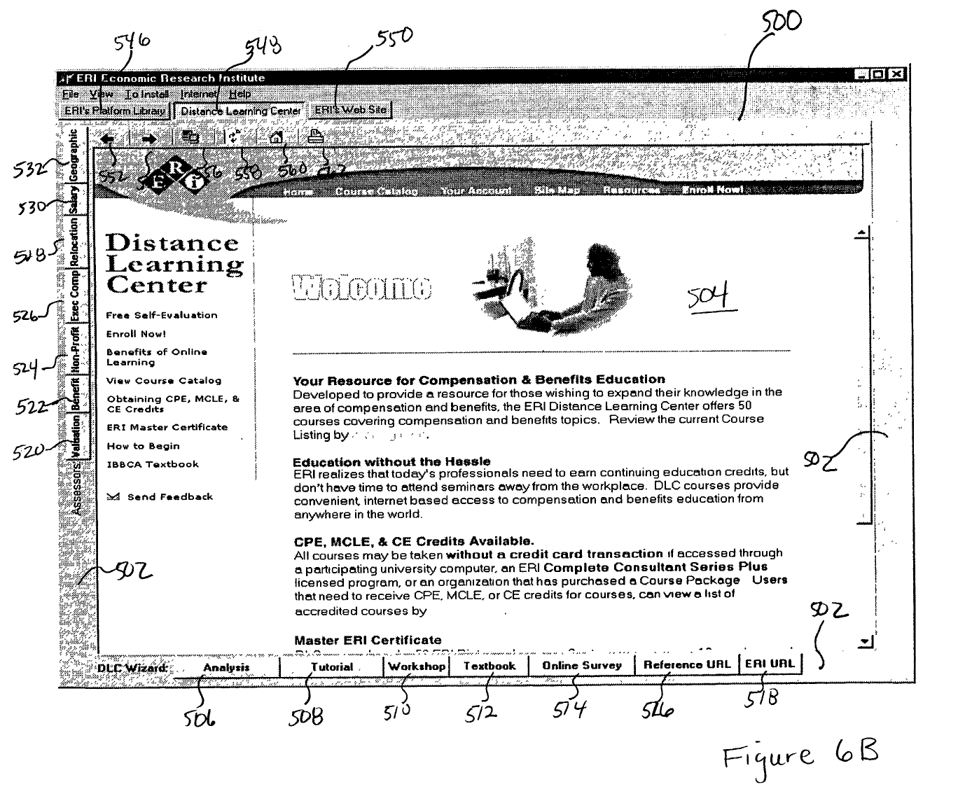

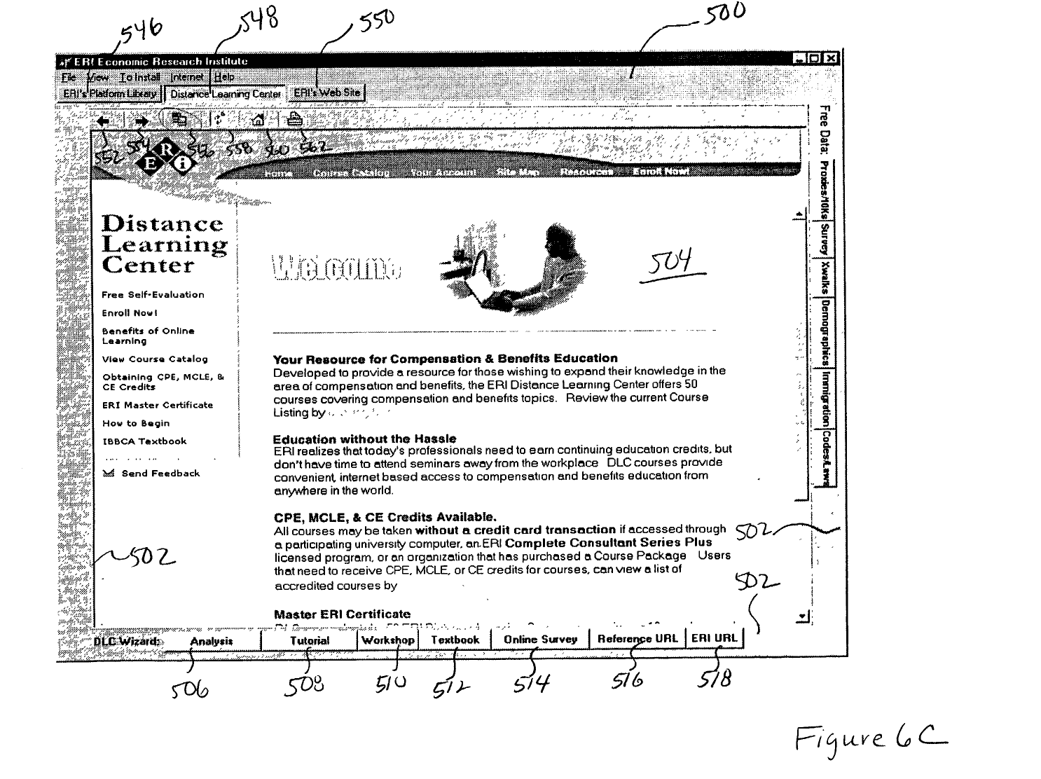

Display pages corresponding to a specific example of an embodiment of the processes represented in FIGS. 3A, 3B and 4 are provided in FIGS. 5-18. Accordingly, the following discussion refers both to the process steps shown in FIGS. 3A, 3B and 4 and the display pages shown in FIGS. 5-18. Beginning with FIG. 3A, in block 302, the web page management component 114 of the server 108 receives a client request for a remote learning system home page. A user may enter a URL on the client computer 102 to access the home page of the remote learning process. In block 304, the web page management component 114 retrieves the requested home page and in block 306 provides the home page. FIG. 5 illustrates an output page displaying a remote learning system home page 500 created under HTML. FIGS. 6A-6C illustrate an output page of another embodiment displaying a remote learning home page 500. FIGS. 5 and 6a-6c will be described in more detail below.

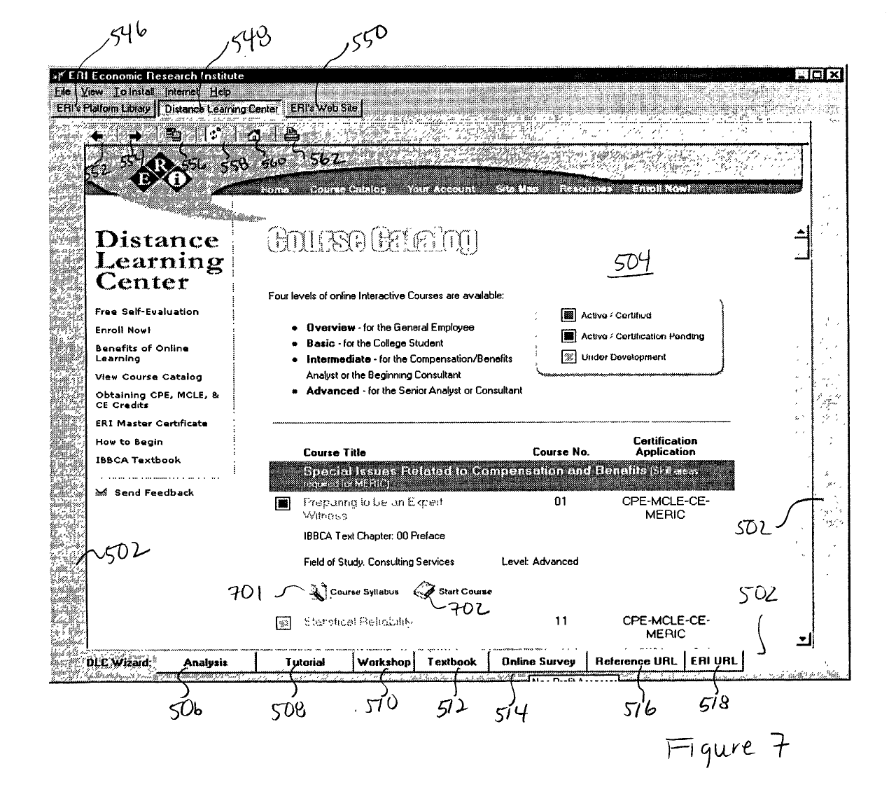

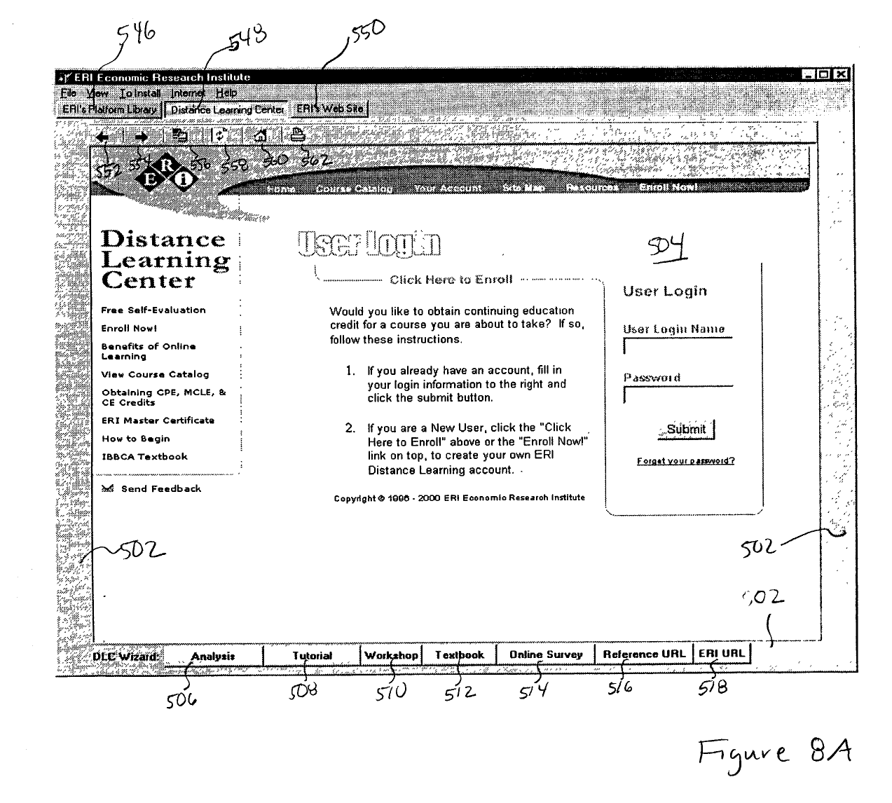

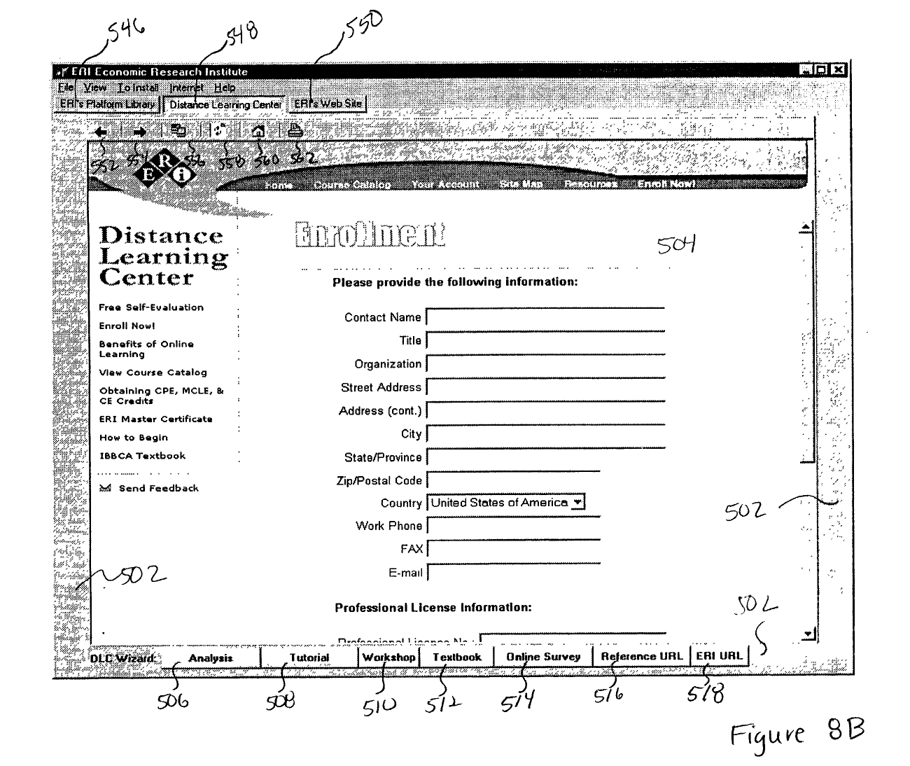

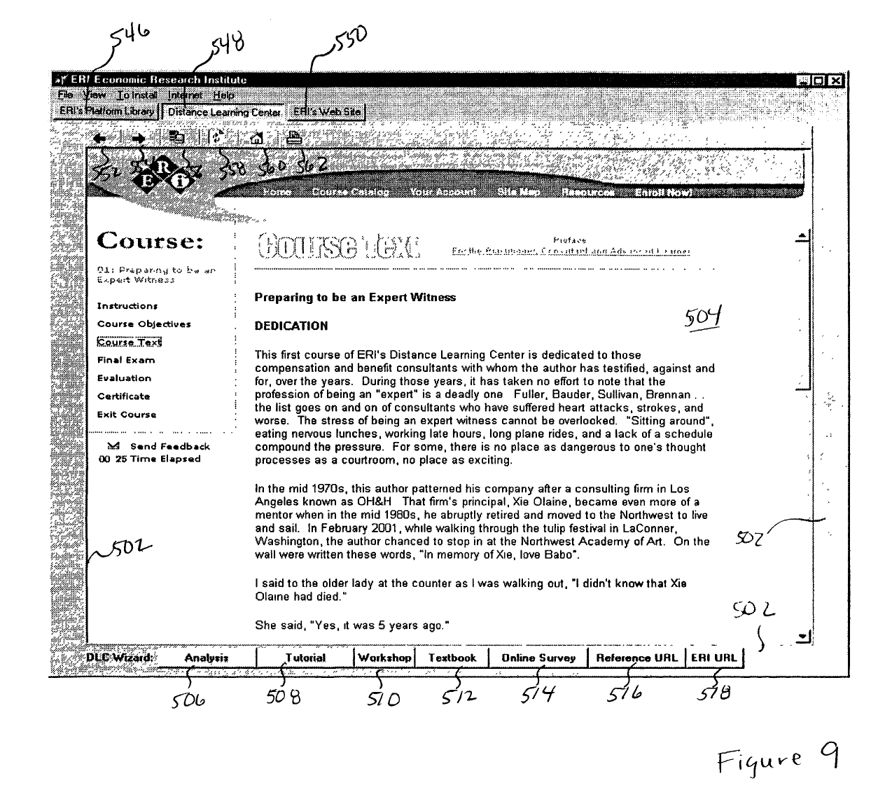

In step 308, the process management component 116 of the server 108 receives a request for displaying a course catalog. In block 310 the database management component 112 retrieves the course catalog and in block 312, the web page management component 114 provides the course catalog to the requesting client computer 102. FIG. 7, illustrates an output page of one embodiment displaying a course catalog. In block 314 the process management component 116 receives a request for a specific course text. In response to this request, in block 316, the database and web page management components 112 and 114 retrieve and provide a user login page. A suitable page for displaying the user login is shown as FIG. 8A. The user, employing the client computer 102, inputs user login information into the self-explanatory fields shown in FIG. 8A. Such user identifying information may include the user's email address and/or password. If the user is a new user to the system, the user will be required to complete an enrollment form. FIG. 8B illustrates a display for a new user enrollment form. The user-input fields shown in FIG. 8B are self-explanatory. In block 318, the process management component 116 receives the user login information. In response to receiving the user login information, in block 320 the database and web page management components 112 and 114 retrieve and provide the requested course text to the client computer 102. FIG. 9 illustrates a suitable display description of a requested course and its corresponding text.

In block 322, while a user is reading the preliminary text of the course, the process management component 116 transmits a client-side virtual picture frame application 118 and client-side executables 120 corresponding to the requested course. FIG. 3B illustrates the exchange of commands and data (through the Internet) between the client computer 102 and the server computer 108 as the user views the remote learning system home page, selects a course and begins the remote course. As shown in FIG. 3B, a user, employing the client computer, inputs a URL for the remote learning system homepage. In response, the server computer provides the home page. The user provides input to view the course catalog. The server computer serves the course catalog page. The user provides input to view a specific course. In response thereto, the server transmits a user login and enrollment page. The user, via the client computer, inputs the user login information. The server creates a user record for a new user. Otherwise, the user logs onto the server computer and the server computer provides the requested course text. While the user is reading the course text, the server transmits the virtual picture frame application and the client-side executables to be downloaded onto the client computer. FIG. 4 illustrates a representative retrieval and display process 400 performed generally by the client computer 102 (FIG. 1). In block 402, the client computer 102 receives and displays the requested course text. The client computer then receives and downloads the client-side virtual picture frame application 118 and the client-side executables 120 in block 404. The virtual picture frame application 118 is an applet that can be downloaded into the memory 230 of a client computer 102 and executed therefrom. The client-side executables 120 are also applications that can be downloaded into the memory 230 of a client computer 102 and executed therefrom. The client-side executables 120 will include one or more of the Assessors 234 customized to the requested course. Referring to FIG. 5, the virtual picture frame 502 surrounds the display of the text in the central window 504 and contains various buttons for accessing information relevant to the selected course, including the client-side executables 120. The various buttons of the virtual picture frame 502 are described in greater detail below. In block 406 of FIG. 4, the client computer 102 receives a request to access a client-side executable 120 when a user clicks on a button on the virtual picture frame 502. Upon receiving the request to access a client-side executable 120, the client computer 102 executes and displays the content in response to the requested executable, as illustrated in blocks 408 and 410.

FIGS. 5 through 18 represent computer displays or web pages with respect to retrieving and displaying information for a remote learning system. The web pages may be implemented in XML (Extensible Markup Language) or HTML (HyperText Markup Language) scripts that provide information to a user. The web pages provide facilities to receive input data, such as in the form of fields of a form to be filled in, pull-down menus or entries allowing one or more of several entries to be selected, buttons, sliders, or other known user interface tools for receiving user input in a web page. Of course, while one or more ways of displaying information to users in pages are shown and described herein, those skilled in the relevant art will recognize that various other alternatives may be employed. The terms “screen,” “web page” and “page” are generally used interchangeably herein. While XML and HTML are described, various other methods of creating displayable data may be employed, such as the Wireless Access Protocol (“WAP”).

The Web pages are stored as display descriptions, graphical user interfaces, or other methods of depicting information on a computer screen (e.g., commands, links, fonts, colors, layout, sizes and relative positions, and the like), where the layout and information or content to be displayed on the page is stored in a database. In general, a “link” refers to any resource locator identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), or matrix or bit-mapped formats. While aspects of the invention are described herein using a networked environment, some or all features may be implemented within a single-computer environment.

Referring to FIG. 5 in greater detail, in one embodiment, the virtual picture frame display 502 surrounds the display of the remote learning system home page and subsequent pages. FIGS. 6A-6C illustrate another embodiment of the virtual picture frame 502. In FIG. 6A, only the bottom edge of the virtual picture frame 502 is visible. However, when the user moves the cursor over the left edge of the central window, the left-hand side of the virtual picture frame appears, as illustrated in FIG. 6B and similarly, FIG. 6C shows that when the user moves the cursor over the right edge of the central window, the right-hand side of the frame 502 appears.

The bottom edge of the virtual picture frame 502 holds buttons to access or launch the executables 236 (FIG. 2), analysis spreadsheets, tutorials, textbooks and a case study relevant to the selected course. As illustrated in FIG. 5, an “Active Analysis” button 506 provides access to an Assessor program assigned to the course selected by the user, such as the Salary Assessor, Geographic Assessor or Relocation Assessor. This assigned Assessor program is used to learn analysis techniques and to answer exam questions. An “Analysis Tutorial” button 508 provides access to instructions for using the corresponding “Active Analysis” 506 program required for the previously selected course. An “Workshop” button 510 provides access to the Benefit Assessor program, which incorporates a case study with data on a sample company for solving complex compensation and benefits administration problems related to the subject of the selected course. An “IBBCA Text” button 514 provides a link to the chapter of the compensation and benefits textbook corresponding to the previously selected course for more in-depth information related to the subject matter of the selected course. An “Online Survey” button 514 provides a link to the Internet site, www.salariesreview.com/surveys, which specializes in compensation, benefit, and cost-of-living surveys for North America and throughout the world. A “Reference URL” button 516 provides links to additional websites that offer more information on the topics at hand. An “ERI URL” button 518 provides a link to the home page found at www.erieri.com and its collection of free information. FIG. 11 illustrates a display of the home page at www.erieri.com. As prompted in the text of a selected course, the user clicks on the appropriate button 506-518 found in the virtual picture frame 502 to access the necessary program, tutorial, textbook chapter or free data.

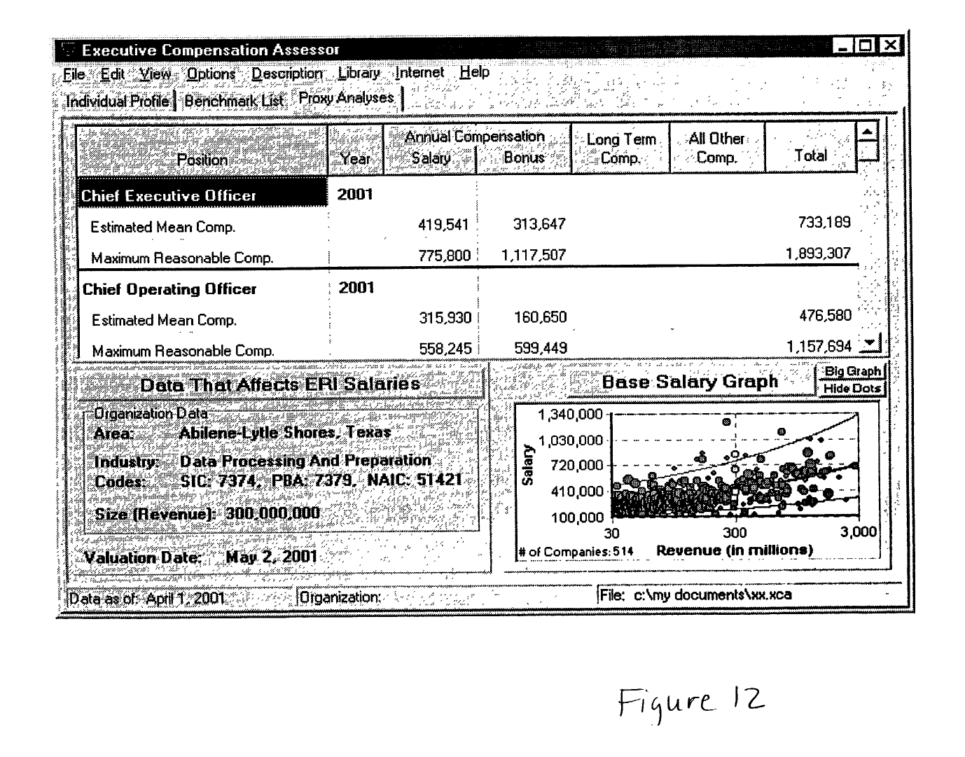

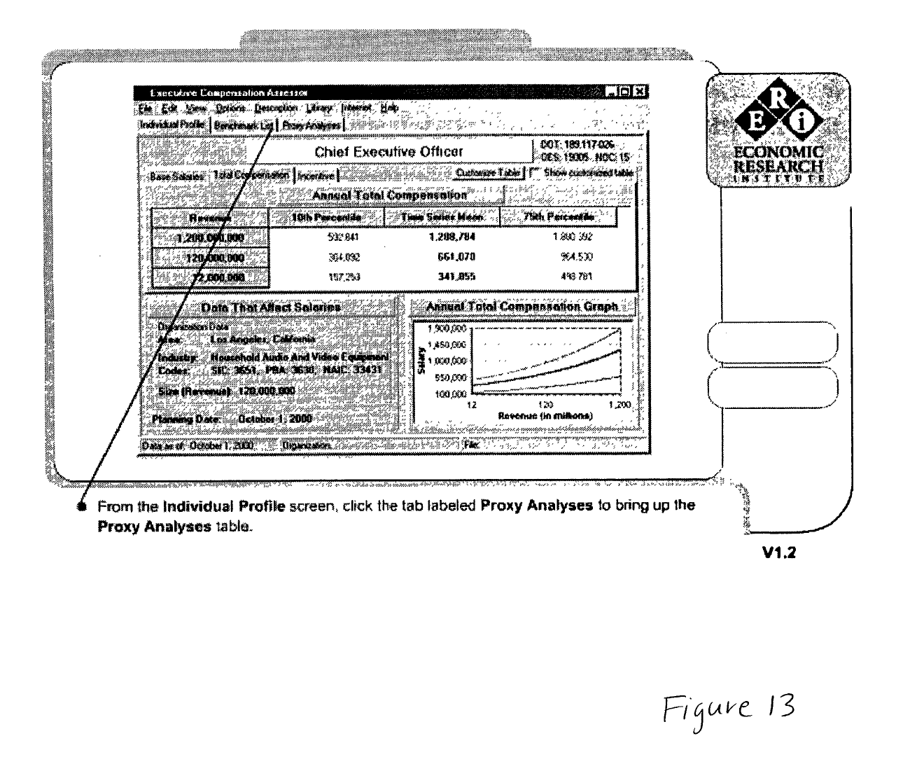

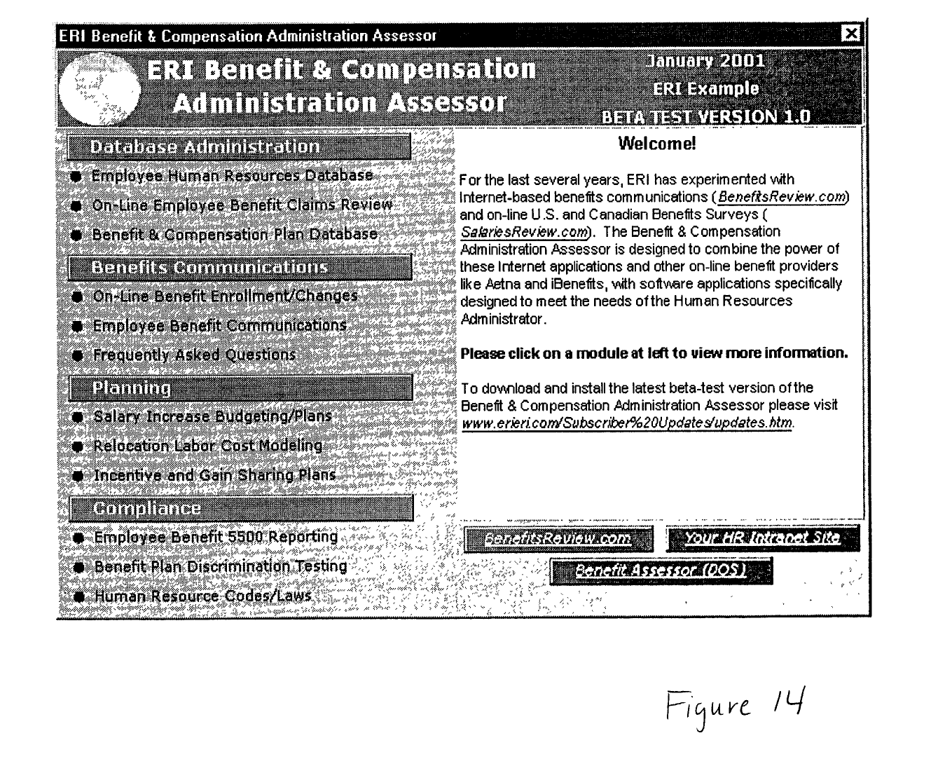

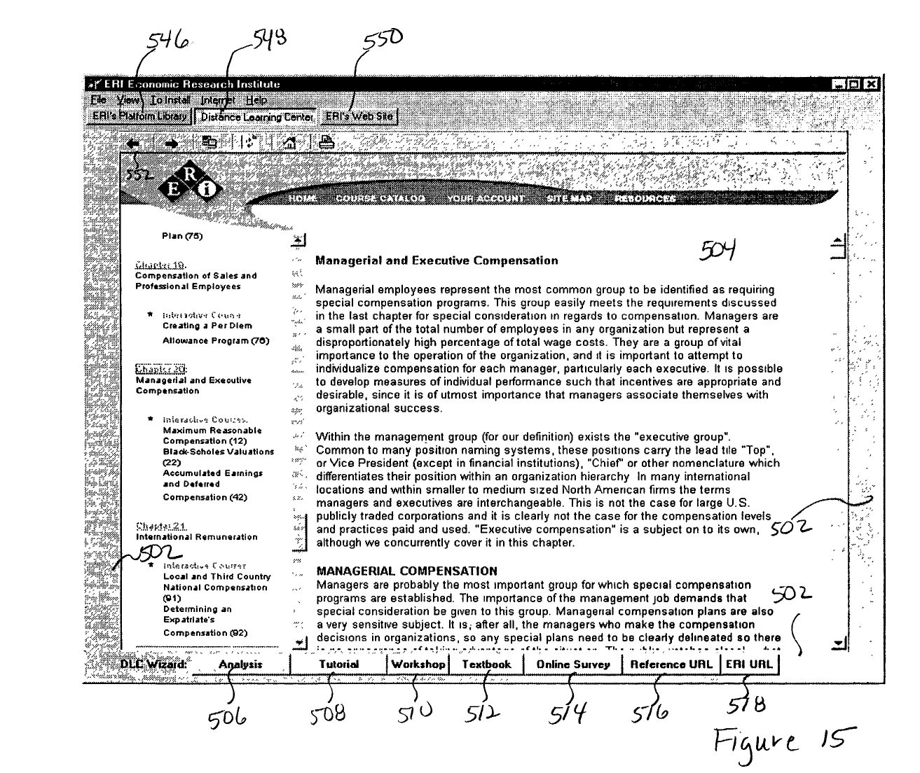

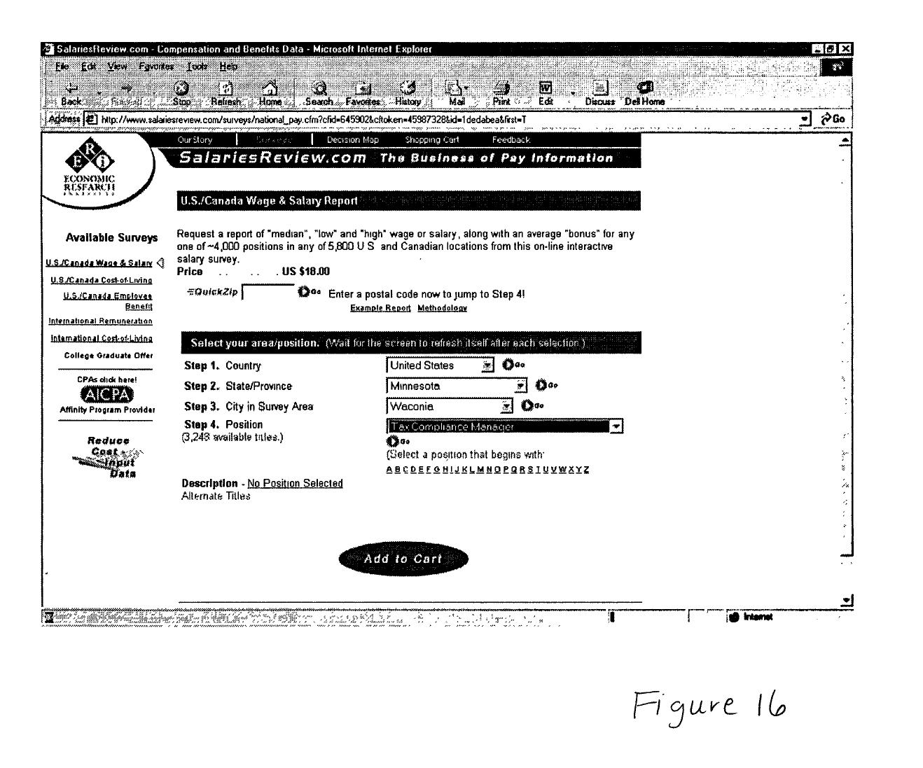

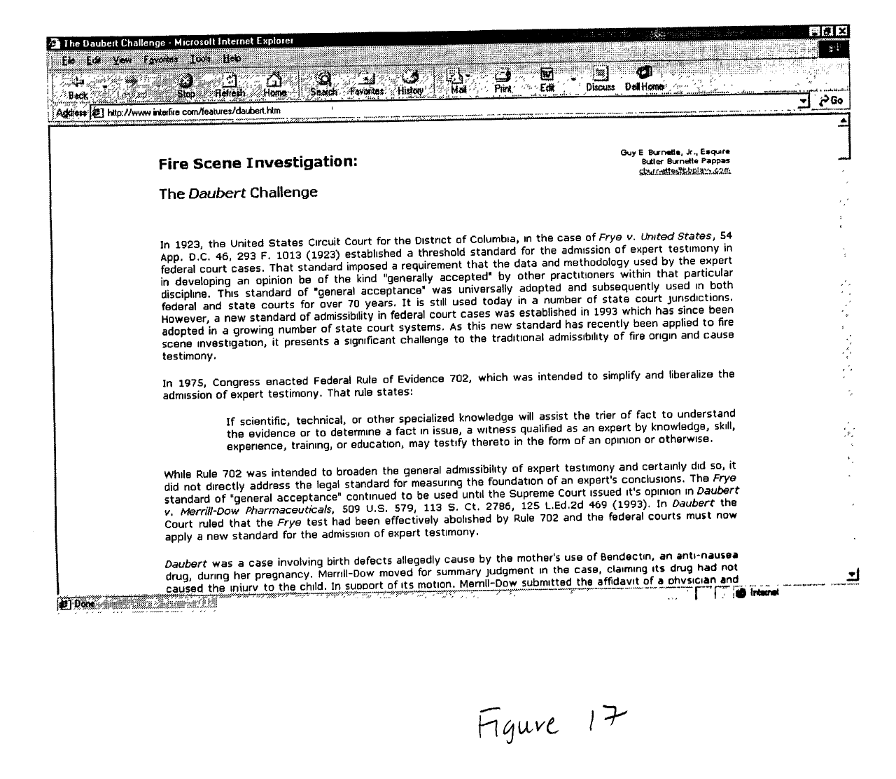

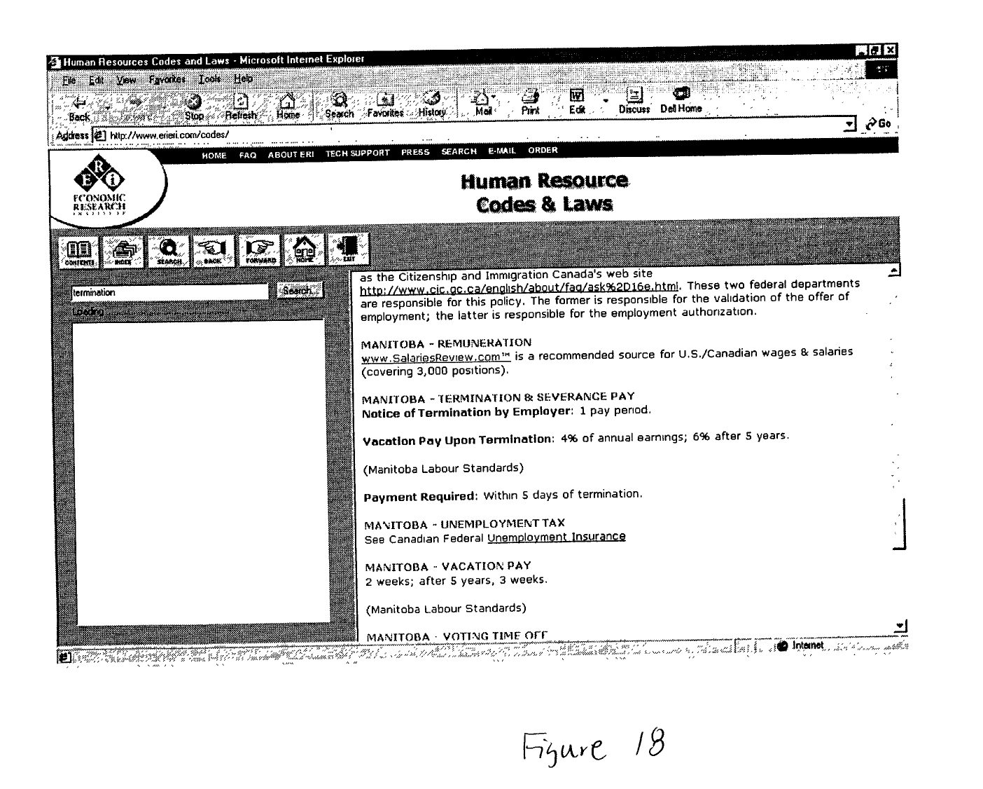

In one embodiment, each course or portion/chapter of a course downloaded by the user begins with 7 lines of code, which map the buttons 506-518 to corresponding content or links. Thus, for content or executables stored locally, the buttons map to path names for accessing the content or executables; for remotely stored content or executables, the buttons map to URLs. For example, referring to FIG. 7, a user may access a course syllabus by clicking on a “Course Syllabus” 701 icon to determine if he or she is interested in taking the remote course. If the user decides to take remote course no. 01, entitled “Preparing to be an Expert Witness,” the user would click on a “Start Course” icon 702 for that course. As prompted throughout the course text, the user will be required to access the Executive Compensation Assessor program, which would be executed by clicking on the “Active Analysis” button 506. FIG. 12 illustrates an example of a display provided under the Executive Compensation Assessor as accessed by clicking on the “Active Analysis” button 506. Clicking on the “Analysis Tutorial” button 508 would access the instructions or using the Executive Compensation Assessor. FIG. 13 provides an example of a display page of the tutorial for using the Executive Compensation Assessor. The Benefits Assessor program would provide a customized case study on compensation and benefits systems in the Internet Environment and would be executed by clicking on the “Workshop” button 510. FIG. 14 illustrates an example of a display page of the Benefits Assessor program. The IBBCA Text associated with the course “Preparing to be an Expert Witness”, would be accessible through clicking on the “IBBCA Text” button 512. FIG. 15 illustrates an example of a display of a chapter in the IBBCA Text. The “Online Survey” button 514 would provide a link to the surveys available at the web site, www.salariesreview.com/surveys. FIG. 16 illustrates an example of a web page from the web site. In this example, the “Reference URL” button 516 may provide a link to a web site regarding caselaw governing expert testimony, such as, www.inerfire.com/features/daubert. Clicking on the “Reference URL” button 516, the user would view a display page, an example of which is illustrated in FIG. 17. Clicking on the “ERI URL” button 518, the user would access the home page found at www.erieri.com and its collection of free information, such as, human resource codes and laws, as illustrated in FIG. 18.

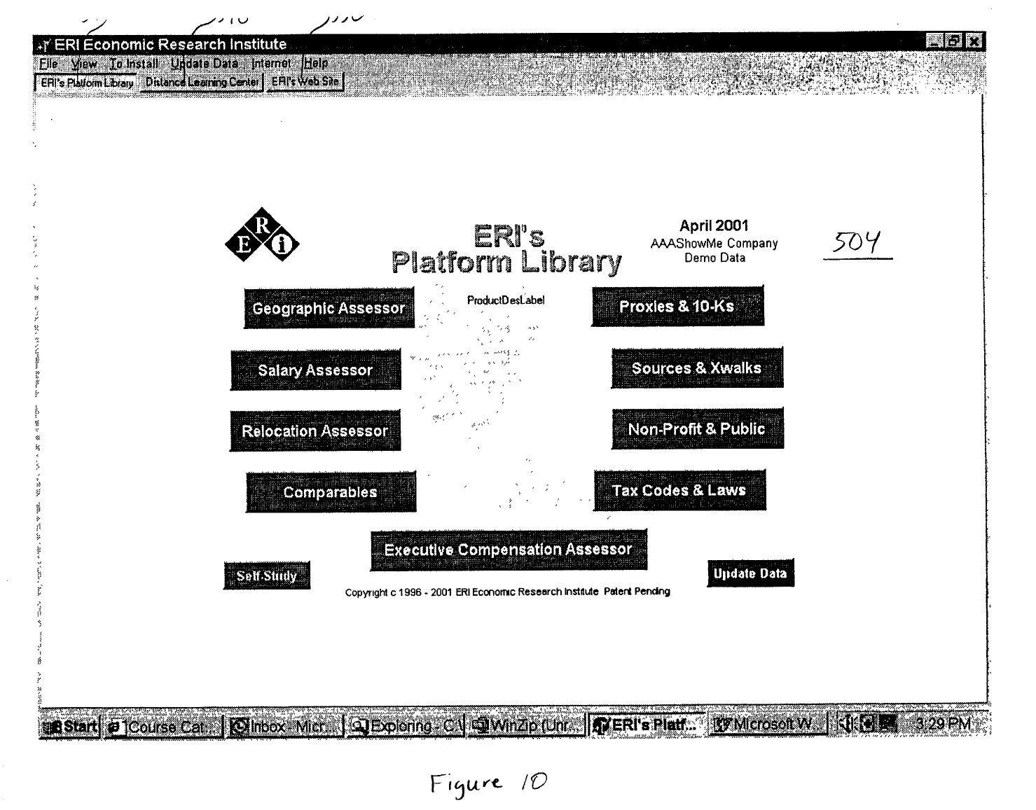

The left-hand side of the virtual picture frame 502 contains Assessor buttons and other buttons, which provide links to the corresponding Assessors 234 (FIG. 2) stored on the memory 230 of the client computer 102 or accessed over the Internet 106 from the database 122 of the server computer 108 or other content. Alternatively, the Assessors 234 could be contained on a CD and read by a CD drive 244. FIG. 10 illustrates the ERI Platform Library, which is comprised of eight different programs, including the Assessors 234 available on a CD. The “Valuation” button 520 provides a link to information regarding publicly held companies. The “Benefits” button 522 provides a link to the corresponding Benefits Assessor program. The “Non-Profit” button 524 provides a link to a corresponding Non-Profit & Public Assessor program. The “Exec Comp” button 526 provides a link to the corresponding Executive Compensation Assessor program. The “Relocation” button 528 provides a link to the corresponding Relocation Assessor program. The “Salary” button 530 provides a link to the corresponding Salary Assessor program. The “Geographic” button 532 provides a link to the corresponding Geographic Assessor program. The Assessors 234 are described at www.erieri.com and are disclosed in co-pending U.S. Application No.______ entitled “System and Method for Retrieving and Displaying Data, such as Economic Data, Relating to Salaries, Cost of Living and Employee Benefits.” (attorney docket no. 33362.8001US) filed concurrently herewith, assigned to the assignee of the present application, and incorporated herein by reference.

The right-hand side of the frame 502 contains buttons that provide links for accessing useful free data. For example, the “Proxies/10ks” button 534 provides a link to over 250,000 proxies, 10ks, Form 990s and other financial records. The “Survey” button 536 provides a link to surveys, such as, salary, cost of living, benefits, executive compensations. The “Xwalks” button 538 provides a link to publicly available information regarding job codes and industry codes. The “Demographics” button 540 provides a link to historical Census and other data for any geographic area. The “immigration” button 542 provides a link to historical data concerning prevailing wages of immigrants. The “Codes/Laws” button 544 provides a link to the tax codes and laws of 209 countries. This free data can also be contained on a CD and read by a CD drive 234 or accessible from the memory 230. The free data also can be accessed over the Internet 106, and can be installed on the server computer 108.

The buttons 552-562 of the top edge of the frame 502 include a series of links provided on most web pages including, links for navigating backward 552 and forward 554, linking to the Internet 556, refreshing a web page 558, accessing the home page 560, and printing 562. The “ERI's Platform Library” button 546 provides access to a website as displayed in FIG. 10. The “Distance Learning Center” button 548 provides access to an output page displaying a remote learning system home page 500 as illustrated in FIG. 5. The “ERI's Web Site” button 550 is a link for accessing a website as illustrated in FIG. 11.

The system 100 may be implemented using Delphi Pascal produced by Borland of Scotts Valley, Calif. Delphi provides an interface for accessing the hidden browser in the Windows Operating System produced by Microsoft Corporation of Redmond, Wash. The hidden browser includes HTML rendering engines for displaying HTML content, such as the web pages disclosed herein. Delphi provides, among other tools, a Shell Doc Object and Control Library to access web browser functionality within the Microsoft Windows Operating System. Thus, the Java scripts and applets described herein are implemented using Delphi, which in turn access the HTML rendering engines of the hidden browser in the Windows Operating System to display the pages described herein. Of course, various other methods may be employed for presenting and displaying the web pages or other interfaces described herein.

Various communication channels may be used for implementing the remote learning system and method described herein, such as a local area network, wide area network, or a point-to-point dial-up connection instead of the Internet. The server system may comprise any combination of hardware or software that can support these concepts. In particular, a web server may actually include multiple computers. A client system may comprise any combination of hardware and software that interacts with the server system. The client systems may include television-based systems, Internet appliances and various other consumer products through which auctions may be conducted, such as wireless computers (palm-based, wearable, mobile phones, etc.). Moreover, the concepts of the present invention may be applied to learning systems that are not supported by computer systems or that are only partially supported by computer systems.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole, and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other media delivery systems, not necessarily for the audio and text delivery system described above. The elements and acts of the various embodiments described above can be combined to provide further embodiments.

All of the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all media delivery systems that operate under the claims to provide a method for providing link character streams with associate aural content. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I claim:

1. A remote learning method for use with a public computer network coupling at least one client computer to a server computer, the method comprising:
receiving over the computer network from a client computer a user selection for a remote educational course;
providing course material, including textual information for the selected course;
providing one or more executable applications to the client computer relevant to the selected course;
providing a virtual picture frame wherein the frame includes one or more links to the executable applications on the client computer;
at the client computer, presenting the virtual picture frame surrounding a display of at least a portion of the textual information for the selected course in a central portion wherein the text requires the user to access one or more of the executable applications;
at the client computer, receiving a user request through a link in the virtual picture frame to access an executable application; and
at the client computer, executing the requested executable application.

2. The method of claim 1, further comprising receiving the client selection for a remote educational course in compensation and benefits.

3. The method of claim 1, wherein providing course material further comprises providing graphs, spreadsheets, examples, and simulations.

4. The method of claim 1 wherein providing the virtual picture frame comprises downloading an applet, and wherein downloading the applet further comprises downloading one or more executable applications.

5. The method of claim 4 wherein providing the virtual picture frame further comprises providing a link for accessing one or more resource URLs.

6. The method of claim 4 wherein downloading one or more executable applications further comprises:
providing an active analysis application; and
providing a workshop application, including sample data for solving problems relevant to the selected course.

7. The method of claim 1 wherein presenting the virtual picture frame further comprises:
displaying a right-hand side of the frame when a cursor is moved over a right edge of the central window portion; and
displaying a left-hand side of the frame when a cursor is moved over a left edge of the central window portion.

8. The method of claim 1 wherein presenting the virtual picture frame further comprises displaying a bottom edge of the frame including an active analysis button, wherein the active analysis button is associated with the link to the executable application.

9. The method of claim 1 wherein presenting the virtual picture frame further comprises displaying a bottom edge of the frame including an analysis tutorial button.

10. The method of claim 1 wherein presenting the virtual picture frame further comprises displaying a bottom edge of the frame including a workshop button wherein the workshop button is associated with the link to the executable application, and wherein the executable application provides at least one case study with sample data on a sample company for solving complex compensation and benefits administration problems related to the subject of the selected course.

11. The method of claim 1 wherein presenting the virtual picture frame further comprises displaying a bottom edge of the frame including a Text button that is associated with a link to a portion of a textbook relevant to the selected course.

12. The method of claim 1 wherein presenting the virtual picture frame further comprises displaying a bottom edge of the frame including an online survey button that is associated with a link to an online survey.

13. The method of claim 1 wherein presenting the virtual picture frame further comprises displaying a bottom edge of the frame including a reference URL button that is associated with a link to at least one reference work relevant to the selected course.

14. The method of claim 1 wherein presenting the virtual picture frame further comprises displaying a bottom edge of the frame including a button associated with a home page for an organization providing the selected course.

15. A remote learning system for use with a computerized network, comprising:
one or more client computers coupled to the computerized network, wherein each client computer provides a client selection for a remote educational course;
a server computer system coupled to the computerized network, wherein the server computer system includes:
at least one server computer for receiving the selection for the remote educational course, retrieving one or more executable applications relevant to the selected course and providing the executable applications to each client computer;
a data storage device coupled to the server computer having a database from which the server computer retrieves data relevant to the selected course; and
wherein the server computer is configured to provide a virtual picture frame wherein the frame surrounds the data relevant to the selected course, and includes one or more buttons with associated links to the executable applications that are executed on the client computer, wherein at least one of the executable applications automatically provides customized executable problems associated with the selected course in response to user selection of one of the buttons.

16. A computer-readable medium storing or transmitting instructions which, when implemented by a computer perform a method for learning course material, comprising:
receiving from a computer a user selection for an educational course;
providing course material, including text;
providing one or more executable applications to the computer relevant to the selected course; and
providing a virtual picture frame wherein the frame surrounds the course material and includes one or more links to the executable applications on the client computer associated with the selected course.

17. The computer-readable medium of claim 16 wherein providing the virtual picture frame comprises downloading an applet, wherein downloading the applet further comprises downloading one or more executable applications.

18. The computer-readable medium of claim 16 wherein providing the virtual picture frame further includes providing links for accessing one or more resource URLs.

19. A method for use with a public computer network coupling at least one client computer to a server computer, the method comprising:
at the server computer, receiving over the computer network from a client computer a client selection for an educational course;
in response to receiving the client selection for an educational course, providing a virtual picture frame having one or more buttons;
at the server computer, providing course material, including text associated with the selected educational course; and
at the server computer, providing one or more executable applications to the client computer relevant to the selected course, wherein at least one executable application is associated with at least one of the buttons and is associated with the selected educational course.

20. The method of claim 19 wherein providing a virtual picture frame includes downloading an applet, wherein downloading the applet further comprises downloading one or more executable applications.

21. The method of claim 19 wherein downloading one or more executable applications further comprises:
providing an active analysis application; and
providing a workshop application, including sample data for solving problems relevant to the selected course.

22. A method for use with a public computer network coupling at least one client computer to a server computer, the method comprising:
at the client computer, providing a client selection for a remote educational course;
receiving course material, including text;
receiving a virtual picture frame;
receiving one or more executable applications;
presenting the virtual picture frame surrounding the text of the selected course, wherein the virtual picture frame includes buttons or links to accessing each of the executable applications and further, wherein the text requires the user to access one or more of the executable applications;
receiving a request from the user through a button or link in the virtual picture frame to access an executable application; and
executing the requested executable application.

23. The method of claim 22, wherein receiving the virtual picture frame includes downloading an applet, wherein downloading the applet includes downloading one or more executable applications.

24. The method of claim 22 wherein receiving course material includes receiving graphs, spreadsheets, examples, or simulations.

25. A computer-readable medium containing a data structure having information for displaying information regarding an education course provided by a remote computer under a client-server system, wherein the client-server system includes a network coupling at least one client computer with a server computer, the information comprising:
a first portion for displaying a virtual picture frame;
a second portion for displaying text of a remote educational course selected by a user, wherein the first portion includes a plurality of buttons, wherein at least one button is associated with executable code configured to present in the second portion problems to be solved by a user under the remote educational course selected by the user, and wherein a second button is associated with reference material relevant to the remote educational course selected by the user, wherein a portion of the reference material relevant to the remote educational course selected by the user is displayable within the second portion.
